(19) United States
(12) Patent Application Publication
(10) Pub. No.: US 2026/0261128 A1
(43) Pub. Date: Sep. 3, 2026

(54) INTELLIGENT ELECTRONIC DEVICE, VOLTAGE CONTROL SYSTEM, AND VOLTAGE CONTROL METHOD

(71) Applicant: Mitsubishi Electric Corporation, Chiyoda-ku, Tokyo (JP)

(72) Inventors: Shunsuke ENDO, Tokyo (JP); Shunsuke KAWANO, Tokyo (JP)

(73) Assignee: Mitsubishi Electric Corporation, Chiyoda-ku, Tokyo (JP)

(21) Appl. No.: 19/158,134

(22) PCT Filed: Mar. 1, 2023
(86) PCT No.: PCT/JP2023/007464

§ 371 Date: Aug. 20, 2025

(51) Int. Cl. H02J 3/38; H02J 3/48; H02J 3/50; H02J 13/12; H02J 13/16; H02J 13/181

(52) U.S. Cl. CPC H02J 3/381; H02J 3/48; H02J 3/50; H02J 13/12; H02J 13/16; H02J 13/181

(57) ABSTRACT

An intelligent electronic device installed in a power distribution system includes a control target acquisition unit configured to acquire information indicating a control target range from a voltage management system, a voltage detection unit configured to detect a voltage of the power distribution system at an installation location of the intelligent electronic device, a controllable quantity acquisition unit configured to acquire information indicating controllable quantity from a distributed energy source connected to the power distribution system, a control quantity calculation unit configured to calculate a control quantity for the distributed energy source so that the control quantity falls within a range of the controllable quantity when a voltage detected by the voltage detection unit is determined to deviate from the control target range, and a control quantity transmission unit configured to transmit the control quantity calculated by the control quantity calculation unit to the distributed energy source.

### CROSS-REFERENCE TO RELATED APPLICATIONS

This application is the United States National Phase under 35 U.S.C. § 371 of PCT International Patent Application No. PCT/JP 2023/007464, filed on Mar. 1, 2023, the disclosure of which is hereby incorporated by reference herein in its entirety.

### TECHNICAL FIELD

The present disclosure relates to an intelligent electronic device, a voltage control system, and a voltage control method.

### BACKGROUND ART

Conventionally, there is a voltage management system that remotely adjusts an SVR (automatic voltage regulator) installed in a power distribution system using a voltage distribution based on past records to maintain a voltage of the power distribution system within an appropriate range. Patent Document 1 discloses a power distribution system monitoring and control method that monitors an amount of electricity in a power distribution line in real time, estimates an amount of load power, and controls opening and closing of opening and closing means related to a power transmission path.

However, with more renewable energy such as that from solar cells being connected to a power distribution system, there is a problem that the voltage management system may not be able to follow sudden load fluctuations or fluctuations in an output of the renewable energy.

### CITATION LIST

### Patent Document

Patent Document 1: Japanese Unexamined Patent Application, First Publication No. H6-189455

### SUMMARY OF INVENTION

### Technical Problem

A problem to be solved is how to control a voltage of a power distribution system in response to sudden load fluctuations or fluctuations in an output of renewable energy.

### Solution to Problem

According to one aspect of the present disclosure, an intelligent electronic device installed in a power distribution system includes a control target acquisition unit configured to acquire information indicating a control target range from a voltage management system, a voltage detection unit configured to detect a voltage of the power distribution system at an installation location of the intelligent electronic device, a controllable quantity acquisition unit configured to acquire information indicating a controllable quantity from a distributed energy source connected to the power distribution system, a control quantity calculation unit configured to calculate a control quantity for the distributed energy source so that the control quantity falls within a range of the controllable quantity when a voltage detected by the voltage detection unit is determined to deviate from the control target range, and a control quantity transmission unit configured to transmit the control quantity calculated by the control quantity calculation unit to the distributed energy source.

In addition, in the intelligent electronic device described above according to the aspect of the present disclosure, information indicating the control target range may include information indicating a control target range for each first period determined in advance, and a detection of the voltage by the voltage detection unit, a calculation of the control quantity by the control quantity calculation unit, and a transmission of the control quantity by the control quantity transmission unit may be performed every second period that is determined in advance and is shorter than the first period.

In addition, in the intelligent electronic device described above according to the aspect of the present disclosure, the controllable quantity acquisition unit may acquire information indicating a controllable quantity every second period.

In addition, in the intelligent electronic device described above according to the aspect of the present disclosure, the control quantity calculated by the control quantity calculation unit may include at least one of a control quantity in a power generation direction, a control quantity in a load direction, a control quantity in a capacitor direction, and a control quantity in a reactor direction.

According to another aspect of the present disclosure, a voltage control system includes an intelligent electronic device that is installed in a power distribution system, and a voltage management system configured to transmit information indicating a control target range to the intelligent electronic device, in which the intelligent electronic device includes a control target acquisition unit that acquires information indicating the control target range from the voltage management system, a voltage detection unit that detects a voltage of the power distribution system at an installation location of the intelligent electronic device, a controllable quantity acquisition unit that acquires information indicating a controllable quantity from a distributed energy source connected to the power distribution system, a control quantity calculation unit that calculates a control quantity for the distributed energy source so that the control quantity falls within a range of the controllable quantity when the voltage detected by the voltage detection unit is determined to deviate from the control target range, and a control quantity transmission unit that transmits the control quantity calculated by the control quantity calculation unit to the distributed energy source.

In addition, the voltage control system according to the aspect of the present disclosure further includes the distributed energy source.

According to still another aspect of the present disclosure, a voltage control method of an intelligent electronic device installed in a power distribution system includes a first step of acquiring information indicating a control target range from a voltage management system, a second step of detecting a voltage of the power distribution system at an installation location of the intelligent electronic device, a third step of acquiring information indicating a controllable quantity from a distributed energy source connected to the power distribution system, a fourth step of calculating a control quantity for the distributed energy source so that the control quantity falls within a range of the controllable quantity when the voltage detected in the second step is determined to deviate from the control target range, and a fifth step of transmitting the control quantity calculated in the fourth step to the distributed energy source.

### Advantageous Effects of Invention

The intelligent electronic device, voltage control system, or voltage control method disclosed herein can control a voltage of a power distribution system in response to a sudden load fluctuation or an output fluctuation of renewable energy.

### BRIEF DESCRIPTION OF DRAWINGS

FIG. 1 depicts a schematic diagram representing a configuration of a voltage control system 10 according to a first embodiment of the present disclosure.

FIG. 2 depicts a graph describing an operation of a voltage management system 100 in the embodiment.

FIG. 3 depicts a schematic block diagram representing a configuration of an IED 400 in the embodiment.

FIG. 4 depicts a table representing an example of stored content of a control target storage unit 402 in the embodiment.

FIG. 5 depicts a table representing an example of stored content of a control parameter storage unit 404 in the embodiment.

FIG. 6 depicts a table representing an example of stored content of an equipment storage unit 406 in the embodiment.

FIG. 7 depicts a table representing an example of stored content of a controllable quantity storage unit 408 in the embodiment.

FIG. 8 depicts a schematic diagram describing setting information of a distributed energy source 500 in the embodiment.

FIG. 9 depicts a time chart describing an operation of the IED 400 in the embodiment.

FIG. 10 depicts a flowchart (part 1) describing an operation of a control quantity calculation unit 409 in the embodiment.

FIG. 11 depicts a flowchart (part 2) describing the operation of the control quantity calculation unit 409 in the embodiment.

FIG. 12 depicts a flowchart (part 3) describing the operation of the control quantity calculation unit 409 in the embodiment.

FIG. 13 depicts a flowchart (part 4) describing the operation of the control quantity calculation unit 409 in the embodiment.

FIG. 14 depicts a flowchart (part 5) describing the operation of the control quantity calculation unit 409 in the embodiment.

FIG. 15 depicts a flowchart (part 6) describing the operation of the control quantity calculation unit 409 in the embodiment.

### DESCRIPTION OF EMBODIMENTS

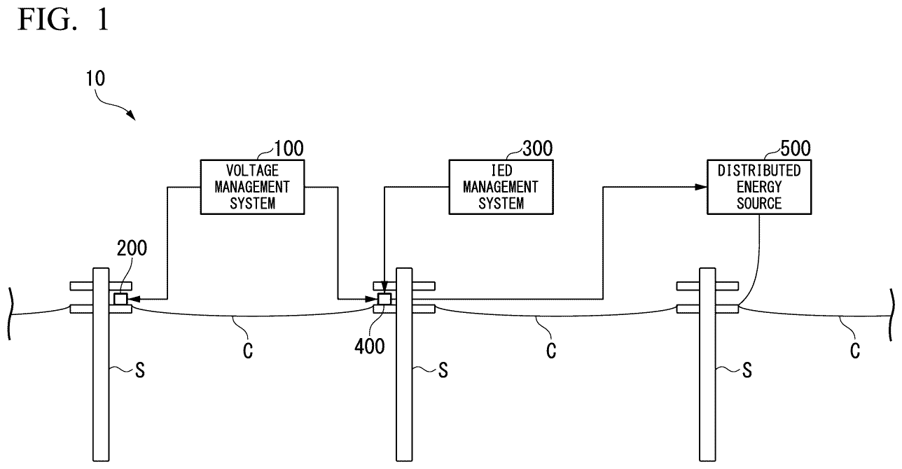

Hereinafter, embodiments of the present disclosure will be described with reference to the drawings. FIG. 1 is a schematic diagram which shows a configuration of a voltage control system 10 according to a first embodiment of the present disclosure. The voltage control system 10 includes a voltage management system 100 and an intelligent electronic device (IED) 400. The voltage control system 10 may include an SVR 200, an IED management system 300, or a distributed energy source (DER; Distributed Energy Resources) 500.

In FIG. 1, a distribution line C is an electric wire of a power distribution system for supplying power to consumers. A utility pole S is a pole for erecting the distribution line C, and the SVR 200, the IED 400, and the like are installed on the utility pole S.

The voltage management system 100 is connected to the SVR 200 and the IED 400 so as to be able to communicate with them. The voltage management system 100 calculates a setting value of the SVR 200 and transmits information indicating the setting value to the SVR 200. Furthermore, the voltage management system 100 calculates a control target range of the IED 400 and transmits information indicating the control target range to the IED 400. For example, the voltage management system 100 calculates and transmits these setting values and control target ranges for 48 sections (portions for 24 hours at 30-minute intervals) on a next day. That is, the voltage management system 100 calculates setting values and control target ranges at 30-minute (first period) intervals and transmits information indicating each to the SVR 200 and the IED 400. Note that this first period is not limited to 30 minutes, and may be shorter or longer than 30 minutes. The voltage management system 100 may also be realized by one or a plurality of computers reading and executing a program.

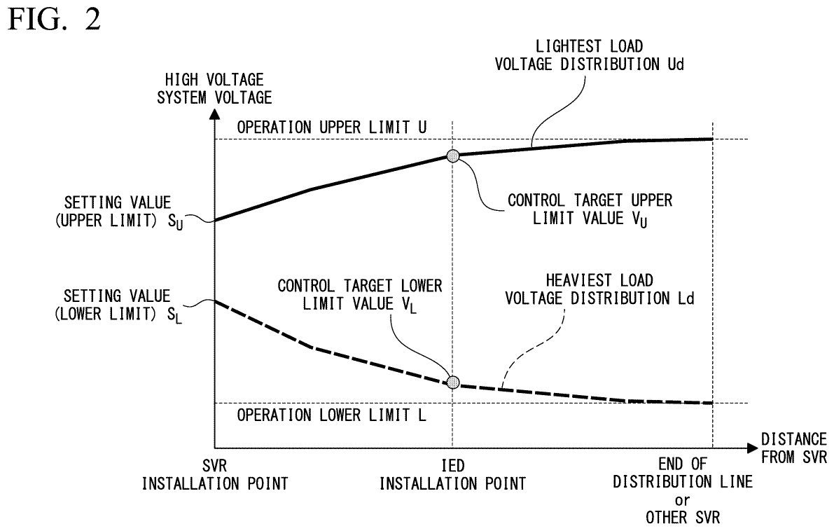

FIG. 2 is a graph that describes an operation of the voltage management system 100 in the present embodiment. In FIG. 2, the horizontal axis represents a distance from the SVR 200, and the vertical axis represents a high-voltage system voltage, i.e., a voltage of the distribution line C. An operation upper limit U and an operation lower limit L are set for the high-voltage system voltage. A voltage at an end of the distribution line or at another SVR is the operation upper limit U, and a voltage distribution in a case with a lightest load among estimated cases is a lightest load voltage distribution Ud. In addition, the voltage at the end of the distribution line or at another SVR is the operation lower limit L, and a voltage distribution in a case with a heaviest load among the estimated cases is a heaviest load voltage distribution Ld. The voltage management system 100 sets the lightest load voltage distribution Ud at an installation point of the SVR 200 as an upper limit setting value S_{U} of the SVR 200, and sets the heaviest load voltage distribution Ld at the installation point of the SVR 200 as a lower limit setting value S_{L} of the SVR 200. Moreover, the voltage management system 100 sets the lightest load voltage distribution Ud at an installation point of the IED 400 as a control target upper limit value Vu, and the heaviest load voltage distribution Ld at an installation point of the IED 400 as a control target lower limit value V_{L}.

Returning to FIG. 1, the SVR 200 acquires the upper limit setting value S_{U} and the lower limit setting value S_{L} from the voltage management system 100. The SVR 200 adjusts the voltage at the installation point of the SVR 200 so that it falls within a range of the upper limit setting value S_{U} and the lower limit setting value S_{L}.

The IED management system 300 is connected to the IED 400 so as to be able to communicate with it. The IED management system 300 sets control parameters in the IED 400 when the IED 400 is installed, maintained, or the like. The control parameters may include any one of a control operation time limit T_{L}, a control period (second period) Tc, a deviation resolution determination voltage width ΔVs, a control attenuation coefficient C, a P sensitivity coefficient K_{P}, and a Q sensitivity coefficient K_{Q}. The IED management system 300 may be connected to the IED 400 so as to be able to communicate with the IED 400 at all times, or may be connected only when the control parameters are set in the IED 400. In addition, the IED management system 300 may be realized by one or the plurality of computers reading and executing a program.

The IED 400 is an intelligent electronic device installed in the power distribution system, and when it is determined that a voltage at the installation location deviates from a control target range acquired from the voltage management system 100, it controls an output of the distributed energy source 500 connected to the power distribution system. When the output of the distributed energy source 500 is controlled, the IED 400 sets the control quantity within a range of a controllable quantity indicated by the information acquired from the distributed energy source 500. In addition, a period for controlling the output of the distributed energy source 500 by the IED 400 may be specified by a control period T_{C} of the control parameters, but the value is shorter than the first period, which is a period of the control target range.

The distributed energy source 500 is an energy source including power generation equipment and power storage equipment that are connected to the power distribution system. The distributed energy source 500 includes power generation equipment using renewable energy such as solar cells. The distributed energy source 500 is connected to the IED 400 so as to be able to communicate with it and transmits information indicating a controllable quantity of an increase or decrease in output to the IED 400.

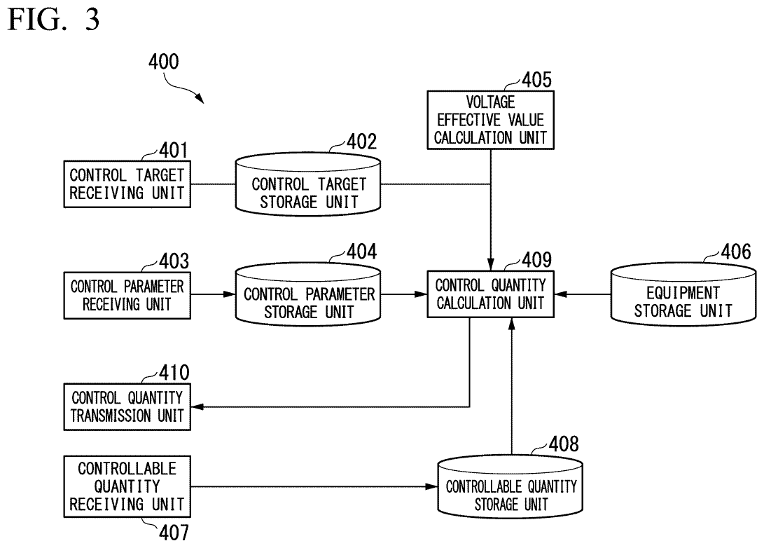

FIG. 3 is a schematic block diagram which shows a configuration of the IED 400 in the present embodiment. The IED 400 includes a control target receiving unit (control target acquisition unit) 401, a control target storage unit 402, a control parameter receiving unit 403, a control parameter storage unit 404, a voltage effective value calculation unit (voltage detection unit) 405, an equipment storage unit 406, a controllable quantity receiving unit (controllable quantity acquisition unit) 407, a controllable quantity storage unit 408, a control quantity calculation unit 409, and a control quantity transmission unit 410. The control target receiving unit 401, the control parameter receiving unit 403, the voltage effective value calculation unit 405, the controllable quantity receiving unit 407, the control quantity calculation unit 409, and the control quantity transmission unit 410 may be configured using a processing device such as a central processing unit (CPU) or a dedicated electronic circuit. The control target storage unit 402, the control parameter storage unit 404, the equipment storage unit 406, and the controllable quantity storage unit 408 are each configured using a storage medium, such as a hard disk drive (HDD), a flash memory, an electrically erasable programmable read only memory (EEPROM), a random access read/write memory (RAM), or a read only memory (ROM), or any combination of these storage media.

The control target receiving unit 401 acquires information indicating a control target range from the voltage management system 100 and stores it in the control target storage unit 402. In the present embodiment, the control target receiving unit 401 receives the control target upper limit value V_{U} and the control target lower limit value V_{L} at 30-minute intervals (first period) as information indicating this control target range, and stores them in the control target storage unit 402. The control target storage unit 402 stores the control target upper limit value V_{U} and the control target lower limit value V_{L} at 30-minute intervals. Note that, the information indicating a control target range is the control target upper limit value V_{U} and the control target lower limit value V_{L} at 30-minute intervals in the present embodiment, but the present invention is not limited to 30-minute intervals and may be at different time intervals.

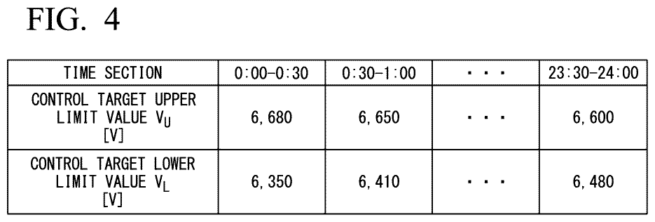

FIG. 4 is a table which shows an example of stored content of the control target storage unit 402 in the present embodiment. In the example shown in FIG. 4, the control target storage unit 402 stores a control target upper limit value V_{U}[V] of “6,680” and a control target lower limit value V_{L}[V] of “6,350” for a time section “0:00-0:30.” Similarly, the control target storage unit 402 stores a control target upper limit value V_{U}[V] of “6,650” and a control target lower limit value V_{L}[V] of “6,410” for a time section “0:30-1:00.” The control target storage unit 402 stores a control target upper limit value V_{U}[V] of “6,600” and a control target lower limit value V_{L}[V] of “6,480” for a time section “23:30-24:00.”

In the example shown in FIG. 4, the control target storage unit 402 stores information indicating a control target range for a current day, but after the control target receiving unit 401 receives information indicating a control target range for the next day, it may store information indicating control target ranges for both the current day and the next day.

Returning to FIG. 3, the control parameter receiving unit 403 receives control parameters from the IED management system 300 and stores them in the control parameter storage unit 404. In the present embodiment, the control parameter receiving unit 403 receives the control operation time limit T_{L}, the control period (second period) T_{C}, the deviation resolution determination voltage width ΔVs, the control attenuation coefficient C, the P sensitivity coefficient K_{P}, and the Q sensitivity coefficient K_{Q} as control parameters, and stores them in the control parameter storage unit 404. The control parameter storage unit 404 stores these control parameters.

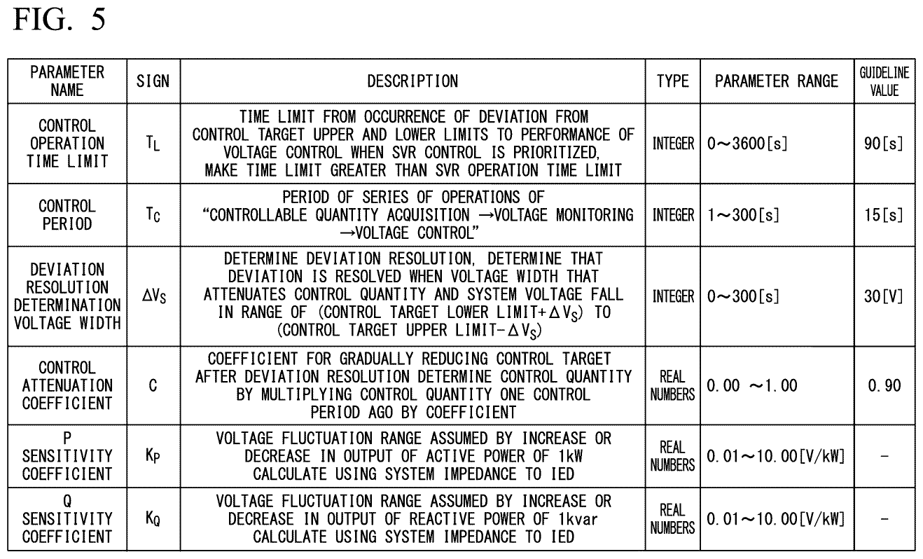

FIG. 5 is a table which shows an example of stored content of the control parameter storage unit 404 in the present embodiment. The control operation time limit T_{L} is a time limit from when a voltage falls outside the control target range to when voltage control is implemented. The control period T_{C} is a period during which the IED 400 acquires a controllable quantity, monitors the voltage, and controls the voltage. The deviation resolution determination voltage width ΔVs is a voltage width used when it is determined that the deviation has been resolved and the control quantity is attenuated. The IED 400 determines that the deviation has been resolved when the voltage of the power distribution system falls within a range of (the control target lower limit value V_{L}+ΔVs) to (the control target upper limit value V_{U}−×Vs). The control attenuation coefficient C is a coefficient for gradually reducing the control target after the deviation has been resolved. The IED 400 determines the control quantity by multiplying the control quantity one control period ago by the control attenuation coefficient C. The P sensitivity coefficient K_{P} is a voltage fluctuation range assumed due to an increase or decrease in output of the active power of 1 kW. The Q sensitivity coefficient K_{Q} is a voltage fluctuation range assumed due to an increase or decrease in output of the reactive power of 1 kvar.

For example, when the voltage of the power distribution system is 6.6 kV, the P sensitivity coefficient K_{P} may be (line resistance R [Ω] from a distribution substation to the IED 400)/6.6 [kV]. Similarly, the Q sensitivity coefficient K_{Q} may be (back impedance of the distribution substation+impedance of the distribution substation LRT (on-load tap changing transformer)+line impedance from the distribution substation to the IED 400) [Ω]/6.6 [kV].

Returning to FIG. 3, the voltage effective value calculation unit 405 detects the voltage of the power distribution system at the installation location of the IED 400. In the present embodiment, the voltage effective value calculation unit 405 detects this voltage by calculating a one-second average of a three-phase average voltage effective value.

The equipment storage unit 406 stores setting information for each distributed energy source 500. This setting information may be set from the IED management system 300.

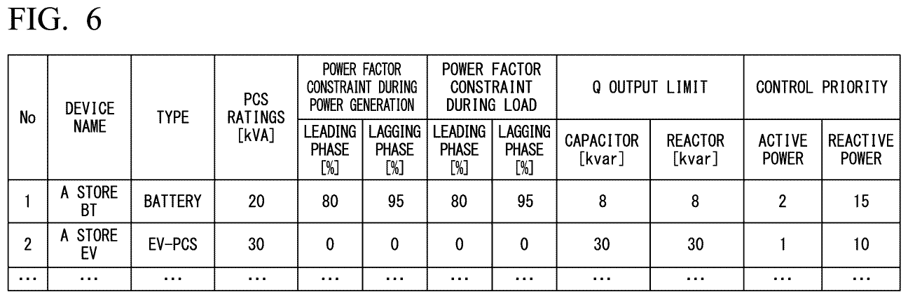

FIG. 6 is a table which shows an example of stored content of the equipment storage unit 406 in the present embodiment. In the example shown in FIG. 6, the equipment storage unit 406 stores, as setting information of a first distributed energy source 500, a No. “1,” a device name “A store BT,” a type “storage battery,” a PCS rating [kVA] “20,” a leading phase [%] “80” and a lagging phase [%] “95” of a power factor constraint during power generation, a leading phase [%] “80” and a lagging phase [%] “95” of a power factor constraint during load, a capacitor [kvar] “8” and a reactor [kvar] “8” of a Q output limit, and active power “2” and reactive power “15” of a control priority in association with each other.

Similarly, the equipment storage unit 406 stores, as setting information of a second distributed energy source 500, a No. “2,” a device name “A store EV,” a type “electric vehicle-power conditioning subsystem (EV-PCS),” a PCS rating [kVA] “30,” a leading phase [%] “0” and a lagging phase [%] “0” of the power factor constraint during power generation, a leading phase [%] “0” and a lagging phase [%] “0” of the power factor constraint during load, a capacitor [kvar] “30” and a reactor [kvar] “30” of the Q output limit, and active power “1” and reactive power “10” of the control priority in association with each other.

Returning to FIG. 3, the controllable quantity receiving unit 407 acquires information indicating a controllable quantity from the distributed energy source 500 connected to the power distribution system, and stores it in the controllable quantity storage unit 408. In the present embodiment, the information indicating a controllable quantity includes at least information indicating the controllable quantity in the power generation direction, information indicating the controllable quantity in the load direction, information indicating the controllable quantity in the capacitor direction, and information indicating the controllable quantity in the reactor direction, but may only include some of these.

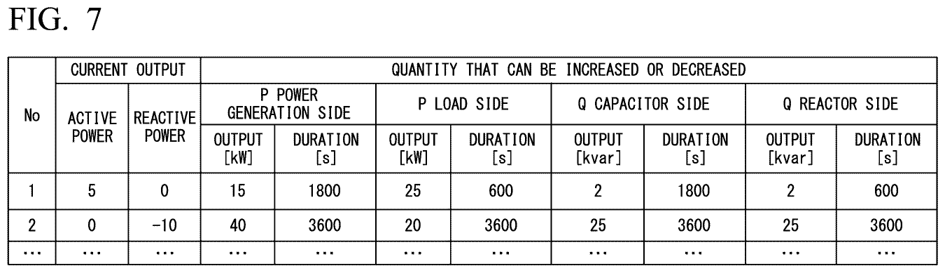

FIG. 7 is a table which shows an example of stored content of the controllable quantity storage unit 408 in the present embodiment. In the example shown in FIG. 7, the controllable quantity storage unit 408 stores, as information indicating the controllable quantity of the first distributed energy source 500, a No. “1,” active power “5” and reactive power “0” of a current output, an output [kW] “15” and duration [s] “1800” on a P power generation side of a quantity that can be increased or decreased, an output [kW] “25” and duration [s] “600” on a P load side, an output [kvar] “2” and duration [s] “1800” on a Q capacitor side, and an output [kvar] “2” and duration [s] “600” on a Q reactor side in association with each other.

Here, the output [kW] “15” on the P power generation side of the quantity that can be increased or decreased is information that indicates the controllable quantity in the power generation direction. The output [kW] “25” on the P load side of the quantity that can be increased or decreased is information that indicates the controllable quantity in the load direction. An output [kvar] “2” on the Q capacitor side of the quantity that can be increased or decreased is information indicating the controllable quantity in the capacitor direction. An output [kvar] “2” on the Q reactor side of the quantity that can be increased or decreased is information indicating the controllable quantity in the reactor direction. Here, the power generation direction is a direction in which the distributed energy source 500 increases active power to be supplied to the power distribution system. The load direction is a direction in which the distributed energy source 500 decreases the active power to be supplied to the power distribution system. The capacitor direction is a direction in which the distributed energy source 500 increases the reactive power to be supplied to the power distribution system. The reactor direction is a direction in which the distributed energy source 500 decreases reactive power to be supplied to the power distribution system.

Similarly, the controllable quantity storage unit 408 stores, as information indicating the controllable quantity of the second distributed energy source 500, a No. “2,” active power “0” and reactive power “−10” of a current output, an output [kW] “40” and duration [s] “3600” on the P power generation side of the quantity that can be increased or decreased, an output [kW] “20” and duration [s] “3600” of an output on the P load side, an output [kW] “25” and duration [s] “3600” on the Q capacitor side, and an output [kW] “25” and duration [s] “3600” on the Q reactor side in association with each other.

Returning to FIG. 3, the control quantity calculation unit 409 determines whether the voltage detected by the voltage effective value calculation unit 405 deviates from the control target range stored in the control target storage unit 402. When it is determined that there is a deviation, the control quantity calculation unit 409 calculates a control quantity for a plurality of distributed energy sources 500 so that it falls within a range of the controllable quantity stored in the controllable quantity storage unit 408. In the present embodiment, this control quantity includes at least one of a control quantity in the power generation direction, a control quantity in the load direction, a control quantity in the capacitor direction, and a control quantity in the reactor direction.

The control quantity transmission unit 410 transmits the control quantity calculated by the control quantity calculation unit 409 to the target distributed energy source 500.

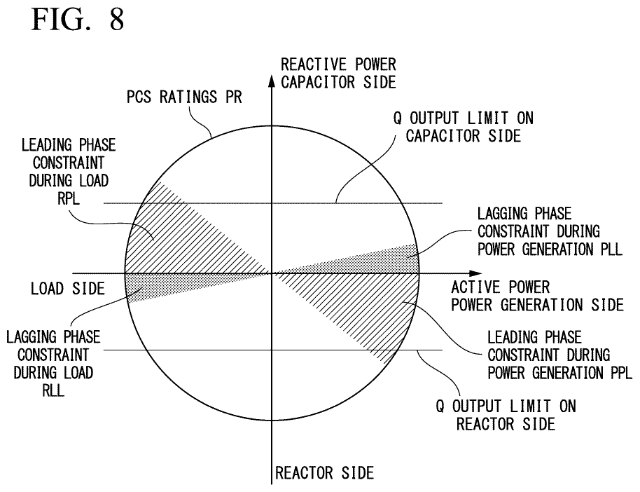

FIG. 8 is a schematic diagram which describes the setting information of the distributed energy source 500 in the present embodiment. In FIG. 8, the horizontal axis represents active power (a power generation side is positive, a load side is negative), and the vertical axis is reactive power (a capacitor side is positive, a reactor side is negative). The PCS rating in FIG. 6 corresponds to a PCS rating PR in FIG. 8, and a radius of the PCS rating PR is determined by a value of the PCS rating. The leading phase of the power factor constraint during power generation in FIG. 6 corresponds to a leading phase constraint during power generation PPL in FIG. 8, and a central angle of the leading phase constraint during power generation PPL is determined by a value of the leading phase of the power factor constraint during power generation. The lagging phase of the power factor constraint during power generation in FIG. 6 corresponds to a lagging phase constraint during power generation PLL in FIG. 8, and a central angle of the lagging phase constraint during power generation PLL is determined by a value of the lagging phase of the power factor constraint during power generation.

The leading phase of the power factor constraint during load in FIG. 6 corresponds to a leading phase constraint during load RPL in FIG. 8, and a central angle of the leading phase constraint during load RPL is determined by a value of the leading phase of the power factor constraint during load. The lagging phase of the power factor constraint during load in FIG. 6 corresponds to a lagging phase constraint during load RLL in FIG. 8, and a central angle of the lagging phase constraint during load RLL is determined by a value of the lagging phase of the power factor constraint during load. A capacitor of a Q output limit in FIG. 6 corresponds to a Q output limit CL on the capacitor side in FIG. 8, and a vertical position of the Q output limit CL on the capacitor-side is determined by a value of the capacitor of the Q output limit. A reactor of the Q output limit in FIG. 6 corresponds to a Q output limit RL on the reactor side in FIG. 8, and a vertical position of the Q output limit RL on the reactor side is determined by a value of the reactor of the Q output limit.

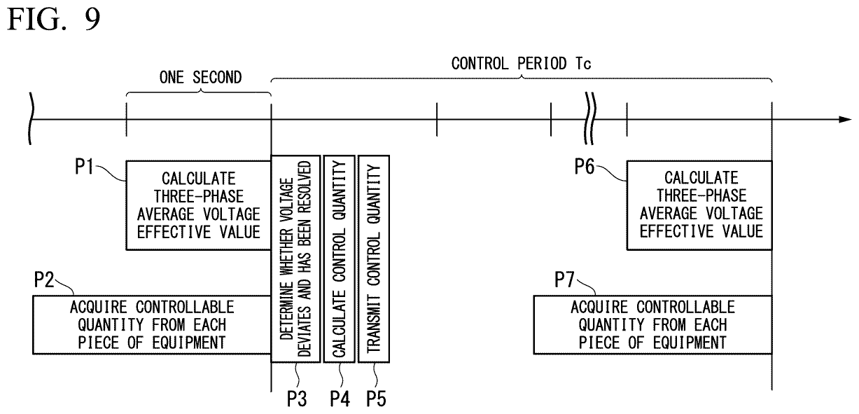

FIG. 9 is a time chart which describes an operation of the IED 400 in the present embodiment. The IED 400 performs voltage control every control period T_{C}. The IED 400 calculates an average value of the three-phase average voltage effective value at the installation location of the IED 400 for one second (period P1) immediately before the control period T_{C}. The IED 400 also acquires information indicating a controllable quantity from each distributed energy source 500 (each piece of equipment) during a period P2 immediately before the control period T_{C}.

Then, when the control period T_{C} begins, during a start period P3, the IED 400 performs processing of determining whether an average value of the three-phase average voltage effective value calculated during the period P1 deviates from the control target range, and whether the deviation has been resolved. During the following period P4, the IED 400 calculates the control quantity for each piece of equipment. During the following period P5, the IED 400 transmits the control quantity to each piece of equipment.

Then, at an end of the control period T_{C}, for the next control period, the IED 400 calculates the average value of the three-phase average voltage effective value (period P6) and acquires information indicating the controllable quantity from each piece of equipment (period P7).

In this manner, the detection of a voltage by the voltage effective value calculation unit 405, the calculation of the control quantity by the control quantity calculation unit 409, and the transmission of the control quantity by the control quantity transmission unit 410 may be performed in the control period T_{C} (second period). This control period T_{C} is shorter than the first period, which is a period of the information indicating the control target range. Furthermore, in the present embodiment, the acquisition of information indicating the controllable quantity by the controllable quantity receiving unit 407 is also performed every second period, but may be performed different from the second period.

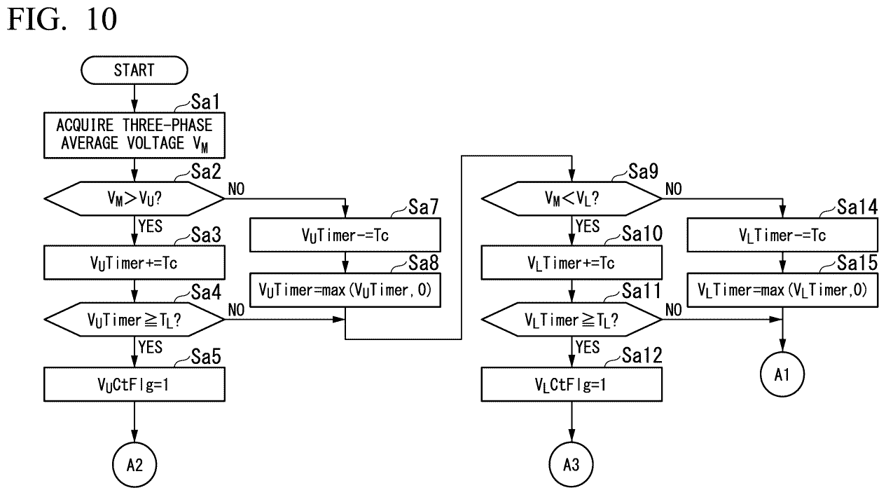

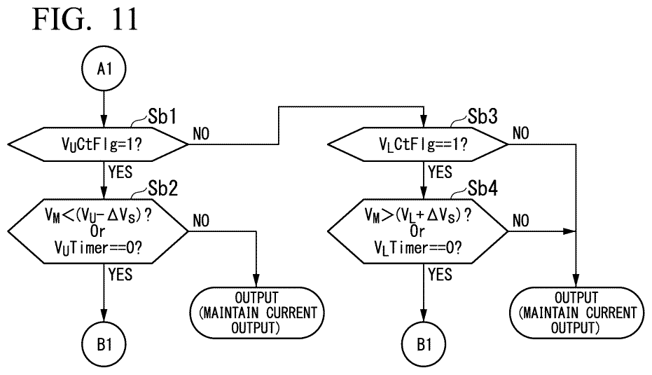

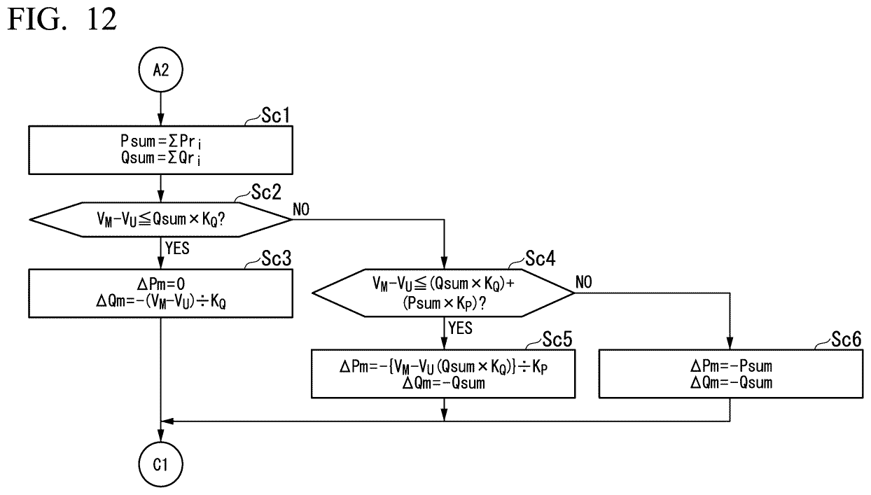

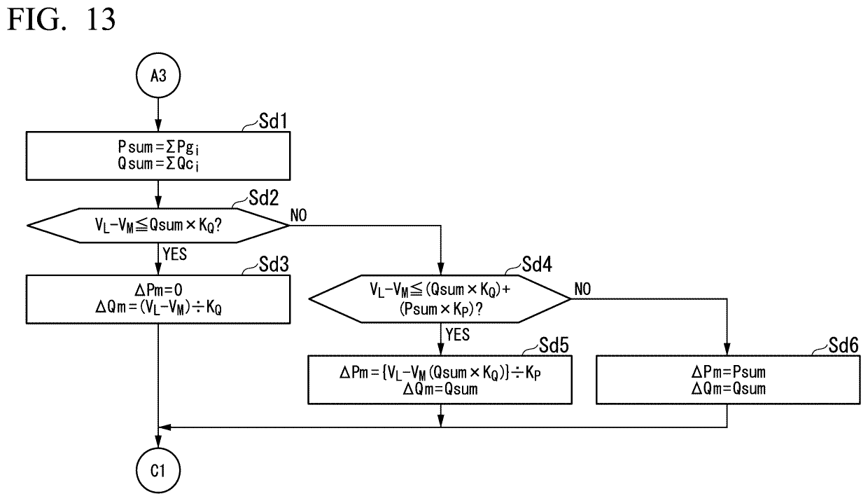

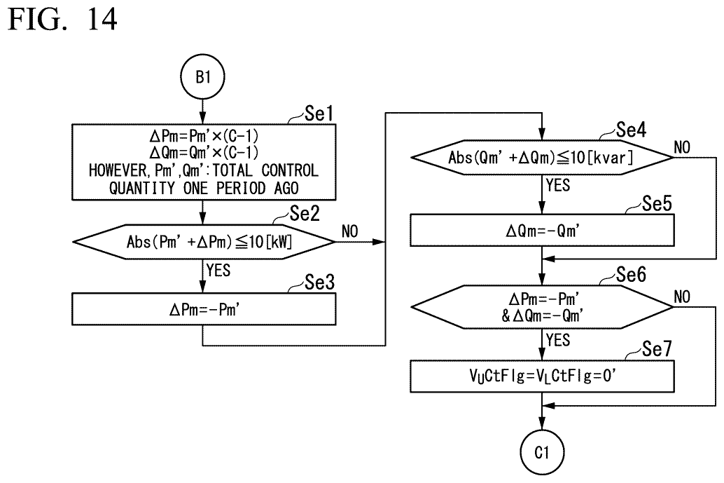

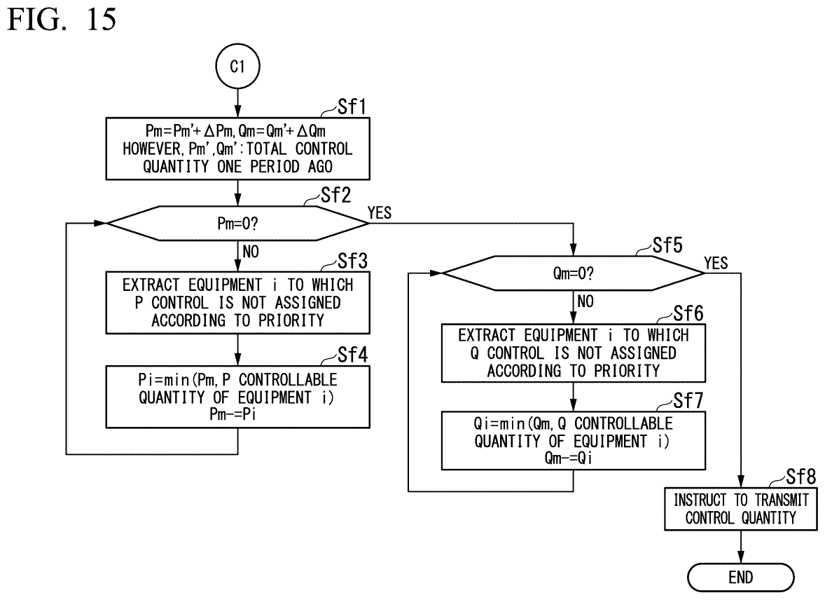

FIGS. 10 to 15 are flowcharts which describe an operation of the control quantity calculation unit 409 in the present embodiment. The operations in FIGS. 10 to 15 correspond to one control period T_{C}. First, the control quantity calculation unit 409 acquires an average value V_{M} of the three-phase average voltage effective value calculated by the voltage effective value calculation unit 405 (step Sa1). Next, the control quantity calculation unit 409 determines whether the average value V_{M} is greater than the control target upper limit value Vᵤ of a time section to which this control period T_{C} belongs (step Sa2). When it is determined that the average value is greater (YES in step Sa2), the control quantity calculation unit 409 counts up an upper limit deviation cumulative time V_{U}Timer by the control period T_{C} (step Sa3). Next, the control quantity calculation unit 409 determines whether the upper limit deviation cumulative time V_{U}Timer is equal to or greater than the control operation time limit T_{L} (step Sa4). When it is determined that the upper limit deviation cumulative time is equal to or greater than the control operation time limit T_{L} (YES in step Sa4), the control quantity calculation unit 409 sets an upper limit deviation suppression control in progress flag V_{U}CtFlg to ON and proceeds to step Sc1.

On the other hand, when it is determined in step Sa2 that the average value V_{M} is not greater than the control target upper limit value V_{U} (NO in step Sa2), the control quantity calculation unit 409 counts down the upper limit deviation cumulative time V_{U}Timer by the control period T_{C} (step Sa7). Next, when a value of the upper limit deviation cumulative time V_{U}Timer becomes negative, the control quantity calculation unit 409 sets the value of the upper limit deviation cumulative time V_{U}Timer to 0 (step Sa8).

When it is determined in step Sa4 that the upper limit deviation cumulative time V_{U}Timer is not greater than the control operation time limit T_{L} (NO in step Sa4), or after step Sa8, the control quantity calculation unit 409 determines whether the average value V_{M} is smaller than the control target lower limit value V_{L} of the time section to which this control period T_{C} belongs (step Sa9). When it is determined that the average value V_{M} is smaller (YES in step Sa9), the control quantity calculation unit 409 counts up the lower limit deviation cumulative time V_{L}Timer by the control period T_{C} (step Sa10). Next, the control quantity calculation unit 409 determines whether the lower limit deviation cumulative time V_{L}Timer is equal to or greater than the control operation time limit T_{L} (step Sa11). When it is determined that the average value V_{M} is equal to or greater than the control operation time limit T_{L} (YES in step Sa11), the control quantity calculation unit 409 sets a lower limit deviation suppression control in progress flag V_{L}CtFlg to ON and proceeds to step Sd1.

On the other hand, when it is determined in step Sa9 that the average value V_{M} is not smaller than the control target lower limit value V_{L} (NO in step Sa9), the control quantity calculation unit 409 counts down the lower limit deviation cumulative time V_{L}Timer by the control period T_{C} (step Sa14). Next, when a value of the lower limit deviation cumulative time V_{L}Timer becomes negative, the control quantity calculation unit 409 sets the value of the lower limit deviation cumulative time V_{L}Timer to 0 (step Sa15).

When it is determined in step Sa11 that the lower limit deviation cumulative time V_{L}Timer is not equal to or greater than the control operation time limit T_{L} (NO in step Sa11), or after step Sa15, the control quantity calculation unit 409 determines whether the upper limit deviation suppression control in progress flag V_{U}CtFlg is ON (step Sb1). When it is determined that the upper limit deviation suppression control in progress flag V_{U}CtFlg is ON (YES in step Sb1), the control quantity calculation unit 409 proceeds to step Sb2.

In step Sb2, the control quantity calculation unit 409 determines whether a condition is satisfied that the average value V_{M} of the three-phase average voltage effective value is smaller than a value obtained by subtracting the deviation resolution determination voltage width ΔVs from the control target upper limit value V_{U}, or whether the upper limit deviation cumulative time V_{U}Timer is 0. When it is determined in step Sb2 that the condition is not satisfied (NO in step Sb2), the control quantity calculation unit 409 ends the processing in this control period T_{C} and maintains a current output of each piece of equipment. When it is determined in step Sb2 that the condition is satisfied (YES in step Sb2), the control quantity calculation unit 409 proceeds to step Se1.

Moreover, when it is determined in step Sb1 that the upper limit deviation suppression control in progress flag V_{U}CtFlg is not ON (NO in step Sb1), the control quantity calculation unit 409 determines whether the lower limit deviation suppression control in progress flag V_{L}CtFlg is ON (step Sb3). When it is determined that the lower limit deviation suppression control in progress flag V_{L}CtFlg is ON (YES in step Sb3), the control quantity calculation unit 409 proceeds to step Sb4.

In step Sb4, the control quantity calculation unit 409 determines whether a condition is satisfied that the average value V_{M} of the three-phase average voltage effective value is greater than a value obtained by adding the deviation resolution determination voltage width ΔVs to the control target lower limit value V_{L}, or that the lower limit deviation cumulative time V_{L}Timer is 0. When it is determined in step Sb4 that the condition is not satisfied (NO in step Sb4), the control quantity calculation unit 409 ends the processing in this control period T_{C} and maintains a current output of each piece of equipment. When it is determined in step Sb4 that the condition is satisfied (YES in step Sb4), the control quantity calculation unit 409 proceeds to step Se1.

In addition, in step Sc1, the control quantity calculation unit 409 calculates a total value Psum of a controllable quantity Pri of each piece of equipment i in the load direction and a total value Qsum of a controllable quantity Qri of each piece of equipment i in the reactor direction. Next, the control quantity calculation unit 409 determines whether a condition that a value obtained by subtracting the control target upper limit value V_{U} from the average value V_{M} of the three-phase average voltage effective value is equal to or less than a value obtained by multiplying the total value Qsum by the Q sensitivity coefficient K_{Q} is satisfied (step Sc2). When it is determined that the condition is satisfied (YES in step Sc2), the control quantity calculation unit 409 sets a control quantity change value ΔPm of the active power to 0. Furthermore, the control quantity calculation unit 409 sets a control quantity change value ΔQm of the reactive power to a value with the sign inverted, obtained by dividing the value obtained by subtracting the control target upper limit value V_{U} from the average value V_{M} of the three-phase average voltage effective value by the Q sensitivity coefficient K_{Q} (step Sc3), and proceeds to step Sf1.

On the other hand, when it is determined in step Sc2 that the condition is not satisfied (NO in step Sc2), the control quantity calculation unit 409 determines whether a condition that the value obtained by subtracting the control target upper limit value V_{U} from the average value V_{M} of the three-phase average voltage effective value is equal to or less than a sum of the value obtained by multiplying the total value Qsum by the Q sensitivity coefficient K_{Q} and a value obtained by multiplying the total value Psum by the P sensitivity coefficient K_{P} is satisfied (step Sc4). When it is determined that the condition is satisfied (YES in step Sc4), the control quantity calculation unit 409 sets the control quantity change value ΔPm of the active power to a value with the sign inverted, obtained by subtracting the control target upper limit value V_{U} from the average value V_{M} of the three-phase average voltage effective value and further subtracting the value obtained by multiplying the total value Qsum by the Q sensitivity coefficient K_{Q}, and dividing the result by the P sensitivity coefficient K_{P}. Furthermore, the control quantity calculation unit 409 sets the control quantity change value ΔQm of the reactive power to the value obtained by inverting the sign of the total value Qsum (step Sc5) and proceeds to step Sf1.

On the other hand, when it is determined in step Sc4 that the condition is not satisfied (NO in step Sc4), the control quantity calculation unit 409 sets the control quantity change value ΔPm of the active power to a value obtained by inverting a sign of the total value Psum, sets the control quantity change value ΔQm of the reactive power to a value obtained by inverting a sign of the total value Qsum (step Sc6), and proceeds to step Sf1.

In addition, in step Sd1, the control quantity calculation unit 409 calculates a total value Psum of a controllable quantity Pgi of each piece of equipment i in the power generation direction, and a total value Qsum of a controllable quantity Qci of each piece of equipment i in the capacitor direction. Next, the control quantity calculation unit 409 determines whether a condition is satisfied that the value obtained by subtracting the average value V_{M} of the three-phase average voltage effective value from the control target lower limit value V_{L} is equal to or less than the value obtained by multiplying the total value Qsum by the Q sensitivity coefficient K_{Q} (step Sd2). When it is determined that the condition is satisfied (YES in step Sd2), the control quantity calculation unit 409 sets the control quantity change value ΔPm of the active power to 0. Furthermore, the control quantity calculation unit 409 sets the control quantity change value ΔQm of the reactive power to a value obtained by subtracting the average value V_{M} of the three-phase average voltage effective value from the control target lower limit value V_{L} and dividing the result by the Q sensitivity coefficient K_{Q} (step Sd3), and proceeds to step Sf1.

On the other hand, when it is determined in step Sd2 that the condition is not satisfied (NO in step Sd2), the control quantity calculation unit 409 determines whether the condition is satisfied that the value obtained by subtracting the average value V_{M} of the three-phase average voltage effective value from the control target lower limit value V_{L} is equal to or less than the sum of the value obtained by multiplying the total value Qsum by the Q sensitivity coefficient K_{Q} and a value obtained by multiplying the total value Psum by the P sensitivity coefficient K_{P} (step Sd4). When it is determined that the condition is satisfied (YES in step Sd4), the control quantity calculation unit 409 sets the control quantity change value ΔPm of the active power to a value obtained by subtracting the average value V_{M} of the three-phase average voltage effective value from the control target lower limit value V_{L}, further subtracting the value obtained by multiplying the total value Qsum by the Q sensitivity coefficient K_{Q}, and dividing the result by the P sensitivity coefficient KP. Furthermore, the control quantity calculation unit 409 sets the control quantity change value ΔQm of the reactive power to the total value Qsum (step Sd5), and proceeds to step Sf1.

On the other hand, when it is determined that the condition is not satisfied in step Sd4 (NO in step Sd4), the control quantity calculation unit 409 sets the control quantity change value ΔPm of the active power to the total value Psum, sets the control quantity change value ΔQm of the reactive power to the total value Qsum (step Sd6), and proceeds to step Sf1.

In step Se1, the control quantity calculation unit 409 sets the control quantity change value ΔPm of the active power to a value obtained by multiplying a total control quantity Pm′ of the active power one control period ago by a value obtained by subtracting 1 from the control attenuation coefficient C, and sets the control quantity change value ΔQm of the reactive power to a value obtained by multiplying a total control quantity Qm′ of the reactive power one period ago by the value obtained by subtracting 1 from the control attenuation coefficient C. Next, the control quantity calculation unit 409 determines whether an absolute value of a value obtained by adding the control quantity change value ΔPm to the total control quantity Pm′ of the active power one control period ago is equal to or less than a predetermined threshold value (for example, 10 [kW]) (step Se2).

When it is determined that the absolute value is equal to or less than the threshold value (YES in step Se2), the control quantity calculation unit 409 sets the control quantity change value ΔPm of the active power to a value obtained by inverting a sign of the total control quantity Pm′ of the active power one control period ago (step Se3). Next, when it is determined in step Se2 that the absolute value is not equal to or less than the threshold value (NO in step Se2), the control quantity calculation unit 409 determines whether an absolute value of a sum of the total control quantity Qm′ of the reactive power one control period ago and the control quantity change value ΔQm is equal to or less than a predetermined threshold value (for example, 10 [kvar]) (step Se4).

When it is determined that the absolute value is equal to or less than the threshold value (YES in step Se4), the control quantity calculation unit 409 sets the control quantity change value ΔQm of the reactive power to a value obtained by inverting a sign of the total control quantity Qm′ of the reactive power one control period ago (step Se5). Next, when it is determined in step Se4 that the absolute value is not equal to or less than the threshold value (NO in step Se4), the control quantity calculation unit 409 determines whether a condition that the control quantity change value ΔPm of the active power is the value obtained by inverting the sign of the total control quantity Pm′ of the active power one control period ago and the control quantity change value ΔQm of the reactive power is the value obtained by inverting the sign of the total control quantity Qm′ of the reactive power one control period ago is satisfied (step Se6).

When it is determined that the condition is satisfied (YES in step Se6), the control quantity calculation unit 409 turns off the upper limit deviation suppression control in progress flag V_{U}CtFlg and the lower limit deviation suppression control in progress flag V_{L}CtFlg (step Se7) and proceeds to step Sf1. When it is determined that the condition is not satisfied (NO in step Se6), the control quantity calculation unit 409 proceeds to step Sf1.

In step Sf1, the control quantity calculation unit 409 sets the total control quantity Pm of the active power to a sum of the total control quantity Pm′ of the active power one control period ago and the control quantity change value ΔPm of the active power, and sets the total control quantity Qm of the reactive power to a sum of the total control quantity Qm′ of the reactive power one control period ago and the control quantity change value ΔQm of the reactive power. Next, the control quantity calculation unit 409 determines whether the total control quantity Pm of the active power is 0 (step Sf2).

When it is determined that the total control quantity Pm of the active power is not 0 (NO in step Sf2), the control quantity calculation unit 409 selects one with the highest priority among pieces of equipment i to which the control quantity of the active power is not assigned (step Sf3). Next, the control quantity calculation unit 409 determines the control quantity Pi of the active power of the selected piece of equipment i to one with the smaller absolute value between the total control quantity Pm of the active power and the controllable quantity of the active power of the equipment i, decrements a value of the total control quantity Pm of the active power by the control quantity Pi of the active power of the equipment i (step Sf4), and returns to step Sf2. Here, when the total control quantity Pm of the active power is positive, an output on the P power generation side is used as the controllable quantity of the active power of the equipment i. In addition, when the total control quantity Pm of the active power is negative, an output on the P load side is used as the controllable quantity of the active power of the equipment i.

On the other hand, when it is determined in step Sf2 that the total control quantity Pm of the active power is 0 (Yes in step Sf2), the control quantity calculation unit 409 determines whether the total control quantity Qm of the reactive power is 0 or not (step Sf5).

When it is determined that the total control quantity Qm of the reactive power is not 0 (NO in step Sf5), the control quantity calculation unit 409 selects one with the highest priority among the pieces of equipment i to which the control quantity of the reactive power is not assigned (step Sf6). Next, the control quantity calculation unit 409 sets the control quantity Qi of the reactive power of the selected equipment i to one with the smaller absolute value between the total control quantity Qm of the reactive power and the controllable quantity of the reactive power of the equipment i, decrements a value of the total control quantity Qm of the reactive power by the control quantity Qi of the reactive power of the equipment i (step Sf7), and returns to step Sf5. Here, when the total control quantity Qm of the reactive power is positive, an output on the Q capacitor side is used as the controllable quantity of the reactive power of the equipment i. In addition, when the total control quantity Qm of the reactive power is negative, an output on the Q reactor side is used as the controllable quantity of the reactive power of the equipment i.

On the other hand, when it is determined in step Sf5 that the total control quantity Qm of the reactive power is 0 (YES in step Sf5), the control quantity calculation unit 409 instructs the control quantity transmission unit 410 to transmit the control quantities Pi and Qi (step Sf8).

The present disclosure may also be embodied as follows.

(1) One embodiment is an intelligent electronic device that is installed in a power distribution system, and includes a control target acquisition unit configured to acquire information indicating a control target range from a voltage management system, a voltage detection unit configured to detect a voltage of the power distribution system at an installation location of the intelligent electronic device, a controllable quantity acquisition unit configured to acquire information indicating controllable quantity from a distributed energy source connected to the power distribution system, a control quantity calculation unit configured to calculate a control quantity for the distributed energy source so that the control quantity falls within a range of the controllable quantity when a voltage detected by the voltage detection unit is determined to deviate from the control target range, and a control quantity transmission unit configured to transmit the control quantity calculated by the control quantity calculation unit to the distributed energy source.

As a result, the intelligent electronic device can control the distributed energy source and control the voltage of the power distribution system in response to sudden load fluctuations or fluctuations in an output of renewable energy.

(2) Another embodiment is the intelligent electronic device described in (1), in which the information indicating the control target range includes information indicating a control target range for each first period determined in advance, and a detection of the voltage by the voltage detection unit, a calculation of the control quantity by the control quantity calculation unit, and a transmission of the control quantity by the control quantity transmission unit are performed every second period that is determined in advance and is shorter than the first period.

As a result, the intelligent electronic device can control the distributed energy source for the second period that is shorter than the first period of the control target range.

(3) Another embodiment is the intelligent electronic device described in (2), in which the controllable quantity acquisition unit acquires information indicating the controllable quantity every second period.

As a result, the intelligent electronic device can control the distributed energy source according to the state at a second period shorter than the first period of the control target range.

(4) Another embodiment is the intelligent electronic device described in any one of (1) to (3), in which the control quantity calculated by the control quantity calculation unit includes at least one of a control quantity in a power generation direction, a control quantity in a load direction, a control quantity in a capacitor direction, and a control quantity in a reactor direction.

As a result, the intelligent electronic device can control the distributed energy source in the power generation direction, the load direction, the capacitor direction, or the reactor direction.

(5) Another embodiment is a voltage control system that includes an intelligent electronic device that is installed in a power distribution system, and a voltage management system configured to transmit information indicating a control target range to the intelligent electronic device, in which the intelligent electronic device includes a control target acquisition unit that acquires information indicating the control target range from the voltage management system, a voltage detection unit that detects a voltage of the power distribution system at an installation location of the intelligent electronic device, a controllable quantity acquisition unit that acquires information indicating a controllable quantity from a distributed energy source connected to the power distribution system, a control quantity calculation unit that calculates a control quantity for the distributed energy source so that the control quantity falls within a range of the controllable quantity when the voltage detected by the voltage detection unit is determined to deviate from the control target range, and a control quantity transmission unit that transmits the control quantity calculated by the control quantity calculation unit to the distributed energy source.

As a result, the voltage control system can control the distributed energy source to control the voltage of the power distribution system in response to sudden load fluctuations or fluctuations in an output of renewable energy.

(6) Another embodiment is the voltage control system described in (5), which includes the distributed energy source.

(7) Another embodiment is a voltage control method of an intelligent electronic device installed in a power distribution system, which includes a first step of acquiring information indicating a control target range from a voltage management system, a second step of detecting a voltage of the power distribution system at an installation location of the intelligent electronic device, a third step of acquiring information indicating a controllable quantity from a distributed energy source connected to the power distribution system, a fourth step of calculating a control quantity for the distributed energy source so that the control quantity falls within a range of the controllable quantity when the voltage detected in the second step is determined to deviate from the control target range, and a fifth step of transmitting the control quantity calculated in the fourth step to the distributed energy source.

As a result, the voltage control method can control the distributed energy source to control the voltage of the power distribution system in response to sudden load fluctuations or fluctuations in an output of renewable energy.

In addition, the voltage management system 100, IED management system 300, and IED 400 may be realized by recording a program for realizing each function of the voltage management system 100, the IED management system 300, and the IED 400 in FIG. 1 on a computer-readable recording medium, and causing a computer system to read and execute the program recorded on the recording medium. Note that the term “computer system” herein includes an OS and hardware such as peripheral devices.

In addition, the term “computer-readable recording medium” refers to a portable medium such as a flexible disk, an optical magnetic disc, a ROM, or a CD-ROM, or a storage device such as a hard disk embedded into the computer system. Furthermore, it is assumed that the term “computer-readable recording medium” includes a medium that dynamically stores a program for a short period of time, like a communication line when transmitting a program via a network such as the Internet or a communication line such as a telephone line, and a medium that holds a program for a certain period of time, like a volatile memory inside the computer system that serves as a server or client in such a case. The program described above may be a program for realizing part of the functions described above, or may be a program that can realize the functions described above in combination with a program already recorded in the computer system.

As described above, the embodiment of this disclosure has been described in detail with reference to the drawings, but a specific configuration is not limited to the present embodiment, and includes design changes within a range that does not depart from the gist of this disclosure.

### REFERENCE SIGNS LIST

10 Voltage control system
100 Voltage management system
200 SVR
300 IED management system
400 IED
401 Control target receiving unit
402 Control target storage unit
403 Control parameter receiving unit
404 Control parameter storage unit
405 Voltage effective value calculation unit
406 Equipment storage unit
407 Controllable quantity receiving unit
408 Controllable quantity storage unit
409 Control quantity calculation unit
410 Control quantity transmission unit
500 Distributed energy source

1. An intelligent electronic device installed in a power distribution system, comprising:
a control target acquisition unit configured to acquire information indicating a control target range from a voltage management system;
a voltage detection unit configured to detect a voltage of the power distribution system at an installation location of the intelligent electronic device;
a controllable quantity acquisition unit configured to acquire information indicating a controllable quantity from a distributed energy source connected to the power distribution system;
a control quantity calculation unit configured to calculate a control quantity for the distributed energy source so that the control quantity falls within a range of the controllable quantity when a voltage detected by the voltage detection unit is determined to deviate from the control target range; and
a control quantity transmission unit configured to transmit the control quantity calculated by the control quantity calculation unit to the distributed energy source,
wherein the control quantity includes an active power and a reactive power of the distributed energy resource,
between the active power and the reactive power, the reactive power takes precedence,
the information indicating the control target range includes information indicating a control target range for each first period determined in advance, the first period being a setting period for a setting value of an automatic voltage regulator installed in the power distribution system, and
a detection of the voltage by the voltage detection unit, a calculation of the control quantity by the control quantity calculation unit, and a transmission of the control quantity by the control quantity transmission unit are performed every second period that is determined in advance and is shorter than the first period.

2. (canceled)

3. The intelligent electronic device according to claim 1,
wherein the controllable quantity acquisition unit acquires information indicating a controllable quantity every second period.

4. The intelligent electronic device according to claim 1,
wherein the control quantity calculated by the control quantity calculation unit includes at least one of a control quantity in a power generation direction, a control quantity in a load direction, a control quantity in a capacitor direction, and a control quantity in a reactor direction.

5. A voltage control system comprising:
an intelligent electronic device that is installed in a power distribution system; and
a voltage management system configured to transmit information indicating a control target range to the intelligent electronic device,
wherein the intelligent electronic device includes
a control target acquisition unit that acquires information indicating the control target range from the voltage management system;
a voltage detection unit that detects a voltage of the power distribution system at an installation location of the intelligent electronic device;
a controllable quantity acquisition unit that acquires information indicating a controllable quantity from a distributed energy source connected to the power distribution system;
a control quantity calculation unit that calculates a control quantity for the distributed energy source so that the control quantity falls within a range of the controllable quantity when the voltage detected by the voltage detection unit is determined to deviate from the control target range; and
a control quantity transmission unit that transmits the control quantity calculated by the control quantity calculation unit to the distributed energy source,
wherein the control quantity includes an active power and a reactive power of the distributed energy resource,
between the active power and the reactive power, the reactive power takes precedence,
the information indicating the control target range includes information indicating a control target range for each first period determined in advance, the first period being a setting period for a setting value of an automatic voltage regulator installed in the power distribution system, and
a detection of the voltage by the voltage detection unit, a calculation of the control quantity by the control quantity calculation unit, and a transmission of the control quantity by the control quantity transmission unit are performed every second period that is determined in advance and is shorter than the first period.

6. The voltage control system according to claim 5, further comprising:
the distributed energy source.

7. A voltage control method of an intelligent electronic device installed in a power distribution system, comprising:
acquiring information indicating a control target range from a voltage management system;
detecting a voltage of the power distribution system at an installation location of the intelligent electronic device;
acquiring information indicating a controllable quantity from a distributed energy source connected to the power distribution system;
calculating a control quantity for the distributed energy source so that the control quantity falls within a range of the controllable quantity when the voltage detected in the second step is determined to deviate from the control target range; and
transmitting the control quantity calculated in the fourth step to the distributed energy source,
wherein the control quantity includes an active power and a reactive power of the distributed energy source,
between the active power and the reactive power, the reactive power takes precedence,
the information indicating the control target range includes information indicating a control target range for each first period determined in advance, the first period being a setting period for a setting value of an automatic voltage regulator installed in the power distribution system, and
the detecting, the calculating, and the transmitting are performed every second period that is determined in advance and is shorter than the first period.
